(19) United States
(12) Patent Application Publication
(10) Pub. No.: US 2010/0180112 A1
(43) Pub. Date: Jul. 15, 2010

(54) Secure Node Admission in a Communication Network

(75) Inventors: Changwen LIU, San Diego, CA (US); Ronald B. LEE, San Diego, CA (US)

Correspondence Address: ENTROPIC COMMUNICATIONS, INC., 6290 SEQUENCE DRIVE, SAN DIEGO, CA, 92121, US

(73) Assignee: ENTROPIC COMMUNICATIONS, INC., San Diego, CA (US)

(21) Appl. No.: 12/686,645

(22) Filed: Jan. 13, 2010

Related U.S. Application Data
(60) Provisional application No. 61/144,570, filed on Jan. 14, 2009.

(51) Int. Cl. H04L 29/06

(52) U.S. Cl. 713/150

(57) ABSTRACT

A system and method for key determination in a communication network having a network control node and a plurality of associated network nodes. According to various embodiments of the disclosed method and apparatus, an entry node sends to the network control node a submission requesting a salt; the entry node receives the salt from the network control node, wherein the salt is a random number generated by the network control node; the entry node combines the salt with its network password to calculate a network admission key; and the entry node submits an admission request to the network controller requesting admission to the network, wherein the admission request is encrypted by the entry node using the admission key.

### CROSS-REFERENCE TO RELATED APPLICATIONS

This application claims the benefit of U.S. Provisional Application No. 61/144,570, filed Jan. 14, 2009, which is herein incorporated by reference in its entirety.

### TECHNICAL FIELD

The presently disclosed method and apparatus relates generally to communication networks, and more particularly, some embodiments relate to secure admission of a node to a communication network.

### SUMMARY

If privacy is enabled, a network controller (NC), such as a c.LINK+ NC MUST admit a node, such as a c.LINK+ node with AES key, and derive all of its static AES keys from one user password. The user password is of effective strength in the range 40˜56 bits while the AES key strength can be up to 128 bits. There is security imparity between the password strength and the maximum AES key strength, which is considered as potential security vulnerability. This disclosure presents a method for fixing the imparity and hence the vulnerability so that an NC can securely admit nodes with encrypted with an encryption scheme such as an AES key and derive strong static AES keys from a weak password.

### BRIEF DESCRIPTION OF THE FIGURES

The disclosed method and apparatus, in accordance with one or more various embodiments, is described in detail with reference to the following FIGURES. The drawings are provided for purposes of illustration only and merely depict either typical embodiments or examples of particular embodiments. These drawings are provided to facilitate the reader's understanding of the disclosed method and apparatus and shall not be considered limiting of the breadth, scope, or applicability of the claimed invention. It should be noted that for clarity and ease of illustration these drawings are not necessarily made to scale.

FIG. 1 is a flow diagram illustrating the flow of messages communicated between nodes of a communication network in accordance with the disclosed method and apparatus.

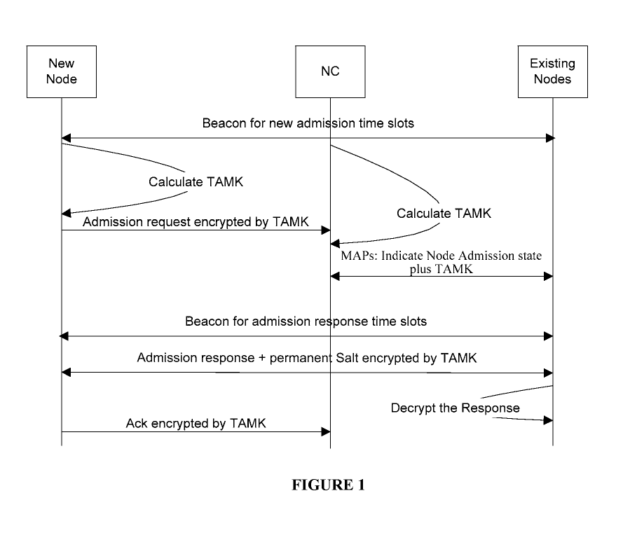

The FIGURES are not intended to be exhaustive or to limit the claimed invention to the precise form disclosed. It should be understood that the disclosed method and apparatus can be practiced with modification and alteration, and that the claimed invention should be limited only by the claims and the equivalents thereof.

### DETAILED DESCRIPTION

Throughout this disclosure, a c.LINK network, and c.LINK+ in particular, are used as examples of a communications network and AES is used as an encryption technique. However, it will be understood by those skilled in the art that these are merely examples and not intended to limit the scope of the concepts being disclosed herein.

c.LINK+ makes use of AES as the base for privacy. The initial admission messages are encrypted by an admission AES key. MAC control messages except the link privacy messages and the initial admission messages are encrypted by the static key of AES MAC Management Key (AMMK). The link privacy messages are encrypted by the static key of AES Initial Privacy Management Key initially (APMKInitial).

An AES key has a length of 128 bits. The user password is used to derive the admission AES key, AMMK, and APMKInitial. The user password consists of 10˜17 digits of decimal numbers for easy input by users. Thus the effective password length (or strength) is between 40 and 56 bits. Due to user friendliness requirement for memorizing and inputting the user password, we cannot increase the length of the user password for the future MoCA revisions, including c.LINK+. We must use the password with strength of 40˜56 bits to derive these AES keys, all with 128 bits in length. If the AES admission key is derived from the user password following any static procedure such as the procedure for the DES key derivation from the password specified in “MoCA MAC/PHY SPECIFICATION v1.0”, September 2007 (developed by the Multimedia over Coax Alliance standard setting organization), then the admission AES key strength will be equal to the password strength, which is 40˜56 bits and much below the maximally possible AES strength of 128 bits. An AES key strength of 40˜56 bits is considered very weak today and suffers from many common vulnerabilities such as pre-calculations of all possible admission AES keys. The same analysis applies to AMMK and APMKInitial.

The strength of the password derived AES admission key, AMMK, and APMKInitial needs to be improved to increase the security of future MoCA. This disclosure presents a method to fulfill the goal of strengthening the password derived AES keys' strength so they have the parity with their intended strength of 128 bits.

A c.LINK+ node MUST follow a dynamic procedure to derive its AES admission key. The AES admission key is named as transient admission management key (TAMK). The dynamic procedure calculates the TAMK not only from the password but also from another dynamic entropy source of ever-changing beacon. The procedure effectively augments the possible key space for the TAMK from 40˜56 bits to about 128 bits.

The TAMK is used for encrypting admission request, response, and acknowledgement of a new node in c.LINK+ mode operation as shown in Error! Reference source not found. Leveraging the beacon that specifies the admission request time slots for a new node during the MoCA admission procedure, the TAMK is calculated from the next two formulas on the fly

Transient Salt=SHA-256(the beacon packet allocating the time slots of the admission request)<0:95>

TAMK=AESKeyGen(Password, Transient Salt,

### “TransientAdmissionManagementKey”)

(See “MoCA MAC/PHY SPECIFICATION v1.0”, September 2007) where the function AESKeyGen is either the function PBKDF1 or the function PBKDF2 defined in RSA Lab, PKCS #5 v2.1: Password-Based Cryptography Standard, Oct. 5, 200 RSA Lab, PKCS #5 v2.1: Password-Based Cryptography Standard, Oct. 5, 2006.

The admission response frame in c.LINK+ MUST advertise a permanent random value of 96 bits or more, which is referred as permanent salt. New node derives its two static AES keys of AES MAC Management Key (AMMK) and AES Initial Privacy Management Key (APMKInitial)) from the permanent salt as below

AMMK=AESKeyGen(Password, Permanent Salt, “MACManagementKey”)

APMKInitial=AESKeyGen(Password, Permanent Salt, “PrivacyManagementKey”)

So both of the keys have strength of 128 bits.

While various embodiments of the disclosed method and apparatus have been described above, it should be understood that they have been presented by way of example only, and not of limitation. Likewise, the various diagrams may depict an example architectural or other configuration for the disclosed method and apparatus, which is done to aid in understanding the features and functionality that can be included in the disclosed method and apparatus. The claimed invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Also, a multitude of different constituent module names other than those depicted herein can be applied to the various partitions. Additionally, with regard to flow diagrams, operational descriptions and method claims, the order in which the blocks are presented herein shall not mandate that various embodiments be implemented to perform the recited functionality in the same order unless the context dictates otherwise.

Although the disclosed method and apparatus is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments which are presented as mere examples for illustration only.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

We claim:

1. A method for admitting a node into a communications network comprising:
a) receiving a beacon from a network controller within the communications network;
b) calculating a transient admission management key (TAMK);
c) encrypting an admission request using the TAMK; and
e) receiving an admission response and permanent salt encrypted by the TAMK.
